(19) United States
(12) Patent Application Publication
(10) Pub. No.: US 2013/0169220 A1
(43) Pub. Date: Jul. 4, 2013

(54) ELECTRICITY TRANSFER SYSTEM AND RELATED SYSTEMS AND METHODS

(71) Applicants: Donald B. Karner, Phoenix, AZ (US); Garrett Beauregard, Phoenix, AZ (US)

(72) Inventors: Donald B. Karner, Phoenix, AZ (US); Garrett Beauregard, Phoenix, AZ (US)

(73) Assignee: Electric Transportation Engineering corporation, d/b/a ECOtality North America, Phoenix, AZ (US)

(21) Appl. No.: 13/341,263

(22) Filed: Dec. 30, 2011

(51) Int. Cl. H02J 7/00; H02J 7/02

(52) U.S. Cl. 320/108; 320/109; 320/128

(57) ABSTRACT

Some embodiments include an electricity transfer system. Other embodiments of related systems and methods are also disclosed.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to an electricity transfer system, and relates more particularly to electricity transfer systems being part of an electricity transfer network and being configured to reduce consumer demand on an electric grid, to provide ancillary services to the electric grid, and/or to shift when the electricity transfer systems draw electricity from the electric grid while also being able to make electricity available to one or more electric vehicle rechargeable energy storage systems and to related systems and methods.

### DESCRIPTION OF THE BACKGROUND

As a result of the ever increasing human population and an ever increasing reliance on electricity for powering electronic devices by people, electric grids are forced to support corresponding increases in demand for electricity. For example, people are increasingly adopting the use of electric vehicle transportation, causing a substantial demand on electric grids as those people charge their electric vehicles. Accordingly, a need or potential for benefit exists for electricity transfer systems that are able to make electricity available to rechargeable energy storage systems of electric vehicles while supporting the electric grids supplying that electricity.

### BRIEF DESCRIPTION OF THE DRAWINGS

To facilitate further description of the embodiments, the following drawings are provided in which:

FIG. 1 illustrates a representative block diagram of an electricity transfer system (ETS) for making electricity available to an electric vehicle rechargeable energy storage system (EVRESS) of an electric vehicle, according to an embodiment;

FIG. 2 illustrates a representative block diagram of an electricity transfer system for making electricity available to multiple electric vehicle rechargeable energy storage systems corresponding to multiple electric vehicles, according to another embodiment;

FIG. 3 illustrates a flow chart for an embodiment of a method for providing an ETS for making electricity available to an EVRESS of an electric vehicle;

FIG. 4 illustrates a flow chart for an exemplary procedure of providing an electric vehicle charging station (EVCS) configured (a) to be coupled to an electric grid such that the EVCS is able to receive electricity from the electric grid and (b) to be coupled to the EVRESS of FIG. 3 to be able to make available the electricity to the EVRESS, according to the embodiment of FIG. 3;

FIG. 5 illustrates a flow chart for an exemplary procedure of providing an electricity transfer system rechargeable energy storage system (ETSRESS) configured (a) to be coupled to the electric grid such that the ETSRESS is able to receive electricity from the electric grid and to be able to make available the electricity to the electric grid and (b) to be coupled to the EVRESS of FIGS. 3 & 4 to be able to make available the electricity to the EVRESS, according to the embodiment of FIGS. 3 & 4;

FIG. 6 illustrates a flow chart for an exemplary procedure of providing a control module, according to the embodiment of FIG. 3;

FIG. 7 illustrates a flow chart for an exemplary procedure of providing a communication module, according to the embodiment of FIG. 3;

FIG. 8 illustrates a flow chart for an embodiment of a method of making electricity available to an electric vehicle rechargeable energy storage system of an electric vehicle;

FIG. 9 illustrates a computer system that is suitable for implementing an embodiment of an electric vehicle charging station computer system, an electricity transfer system network computer system, and/or an electric grid computer system, according to the embodiments of FIGS. 1-9; and

FIG. 10 illustrates a representative block diagram of exemplary components and/or circuitry included in exemplary circuit boards inside a chassis of the computer system of FIG. 9.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “real time” is defined with respect to operations carried out as soon as practically possible upon occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

### DETAILED DESCRIPTION OF EXAMPLES OF EMBODIMENTS

Some embodiments include an electricity transfer system for making electricity available to an electric vehicle rechargeable energy storage system of an electric vehicle. The electric vehicle rechargeable energy storage system can be configured with an electricity transfer rating of greater than or equal to approximately (¼)C and with an electric energy storage capacity of greater than or equal to approximately 1 kiloWatt-hour. The electricity transfer system comprises an electric vehicle charging station, an electricity transfer system rechargeable energy storage system, a control module, and a communication module. The electric vehicle charging station is configured (a) to be coupled to an electric grid such that the electric vehicle charging station is able to (i) receive the electricity from the electric grid and make the electricity available to the electric grid and (b) to be coupled to the electric vehicle rechargeable energy storage system to be able to make the electricity available to the electric vehicle rechargeable energy storage system. Meanwhile, the electricity transfer system rechargeable energy storage system is configured (a) to be coupled to the electric grid such that the electricity transfer system rechargeable energy storage system is able to (i) receive the electricity from the electric grid and (ii) make the electricity available to the electric grid and (b) to be coupled to the electric vehicle rechargeable energy storage system to be able to make the electricity available to the electric vehicle rechargeable energy storage system. The communication module is configured to communicate with the control module. Additionally, the control module is configured to control when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system. Furthermore, the communication module can be configured to communicate with an electric grid computer system of the electric grid and the electric vehicle in order to permit the control module to determine when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system.

Various embodiments include a method for providing an electricity transfer system for making electricity available to an electric vehicle rechargeable energy storage system of an electric vehicle. The electric vehicle rechargeable energy storage system can be configured with an electricity transfer rating of greater than or equal to approximately (¼)C and with an electric energy storage capacity of greater than or equal to approximately 1 kiloWatt-hour. The method comprises: providing an electric vehicle charging station configured (a) to be coupled to an electric grid such that the electric vehicle charging station is able to (i) receive the electricity from the electric grid and (ii) make available the electricity to the electric grid and (b) to be coupled to the electric vehicle rechargeable energy storage system to be able to make the electricity available to the electric vehicle rechargeable energy storage system; providing an electricity transfer system rechargeable energy storage system configured (a) to be coupled to the electric grid such that the electricity transfer system rechargeable energy storage system is able to (i) receive the electricity from the electric grid and (ii) make the electricity available to the electric grid and (b) to be coupled to the electric vehicle rechargeable energy storage system to be able to make the electricity available to the electric vehicle rechargeable energy storage system; providing a control module wherein providing the control module comprises configuring the control module to control when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system; and providing a communication module wherein providing the communication module comprises configuring the communication module to communicate with an electric grid computer system of the electric grid and the electric vehicle in order to permit the control module to determine when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system.

Further embodiments include a method of making electricity available to an electric vehicle rechargeable energy storage system of an electric vehicle. The electric vehicle rechargeable energy storage system can be configured with an electricity transfer rating of greater than or equal to approximately (¼)C and with an electric energy storage capacity of greater than or equal to approximately 1 kiloWatt-hour. The method comprises: facilitating use of an electric vehicle charging station configured (a) to be coupled to an electric grid such that the electric vehicle charging station is able to (i) receive the electricity from the electric grid and (ii) make the electricity available to the electric grid and (b) to be coupled to the electric vehicle rechargeable energy storage system to be able to make the electricity available to the electric vehicle rechargeable energy storage system; facilitating use of an electricity transfer system rechargeable energy storage system configured (a) to be coupled to the electric grid such that the electricity transfer system rechargeable energy storage system is able to (i) receive the electricity from the electric grid and (ii) make the electricity available to the electric grid and (b) to be coupled to the electric vehicle rechargeable energy storage system to be able to make the electricity available to the electric vehicle rechargeable energy storage system; controlling when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system; and communicating with an electric grid computer system of the electric grid and the electric vehicle in order to determine when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system.

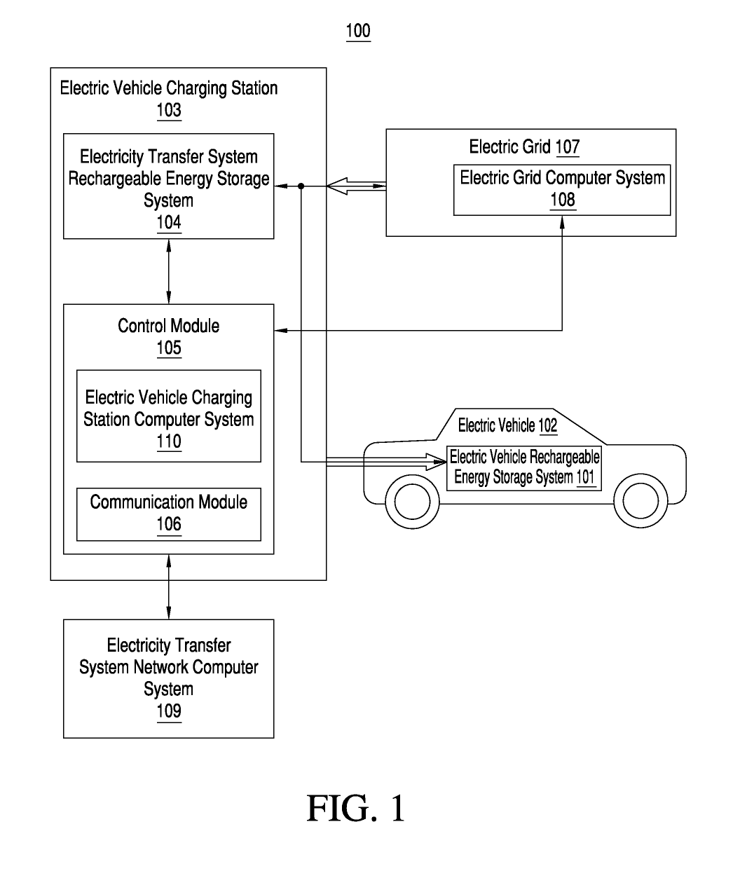

Turning to the drawings, FIG. 1 illustrates a representative block diagram of electricity transfer system (ETS) 100 for making electricity available (e.g., via fast charging) to electric vehicle rechargeable energy storage system (EVRESS) 101 of electric vehicle 102, according to an embodiment. ETS 100 is merely exemplary and is not limited to the embodiments presented herein. ETS 100 can be employed in many different embodiments or examples not specifically depicted or described herein.

EVRESS 101 can be configured to provide electricity to electric vehicle 102 to provide motive (e.g., traction) electrical power to electric vehicle 102 and/or to provide electricity to any electrically operated components of electric vehicle 102. Accordingly, EVRESS 101 can be configured with and/or can comprise an electricity transfer rating of greater than or equal to approximately (¼)C (e.g., approximately 2C, approximately 3C, etc.), where the electricity transfer rating refers to an electricity charge and/or discharge rating of EVRESS 101 in terms of the electric current capacity of EVRESS 101 in ampere-hours. Furthermore, EVRESS 101 can also be configured with and/or can comprise an electric energy storage capacity of greater than or equal to approximately 1 kiloWatt-hour (kW-hr). For example, EVRESS 101 can be configured with and/or can comprise an electric energy storage capacity of greater than or equal to approximately 20 kW-hrs and less than or equal to approximately 50 kW-hrs.

In specific examples, EVRESS 101 can comprise (a) one or more batteries and/or one or more fuel cells, (b) one or more capacitive energy storage systems (e.g., super capacitors such as electric double-layer capacitors), and/or (c) one or more inertial energy storage systems (e.g., one or more flywheels). In many embodiments, the one or more batteries can comprise one or more rechargeable and/or non-rechargeable batteries. For example, the one or more batteries can comprise one or more lead-acid batteries, valve regulated lead acid (VRLA) batteries such as gel batteries and/or absorbed glass mat (AGM) batteries, nickel-cadmium (NiCd) batteries, nickel-zinc (NiZn) batteries, nickel metal hydride (NiMH) batteries, zebra (e.g., molten chloroaluminate (NaAlCl₄)) batteries, and/or lithium (e.g., lithium-ion (Li-ion)) batteries. Meanwhile, electric vehicle 102 can comprise any full electric vehicle, any hybrid vehicle, and/or any other grid-connected vehicle. In the same or different embodiments, the electric vehicle can comprise any one of a car, a truck, motorcycle, a bicycle, a scooter, a boat, a train, an aircraft, an airport ground support equipment, and/or a material handling equipment (e.g., a fork-lift), etc.

EVRESS 101 and/or electric vehicle 102 can comprise an energy management system (EMS). For example, where EVRESS 101 comprises one or more batteries, EVRESS 101 can comprise a battery EMS. The EMS can comprise varying levels of sophistication. For example, in some embodiments, the EMS can be configured to utilize charging algorithms to calculate dynamic charging conditions of EVRESS 101, which are described in greater detail below. Meanwhile, the EMS can also be configured to utilize other charging algorithms to calculate and/or can store static charging conditions of EVRESS 101, which are also described in greater detail below. In other embodiments, where EMS comprises less sophistication, functionality permitting EMS to calculate dynamics charging conditions and/or to calculate static charging conditions can be omitted. For example, in these embodiments, the EMS can merely be programmed to store static charging conditions of EVRESS 101. Further to these examples, the EMS in these embodiments can be referred to as a personality module.

In some embodiments, ETS 100 can be part of an electricity transfer system network comprising the ETS shown in FIG. 1 and one or more other electricity transfer systems similar or identical to the ETS shown in FIG. 1. The electricity transfer system network can be administrated via electricity transfer system network (ETSN) computer system 109 by an operating entity using and/or managing ETSN computer system 109. Users of the electricity transfer system network can be customers of the operating entity and, in some embodiments, users of the electricity transfer system network can establish user accounts after the operating entity permits such users to use the electricity transfer system network. Furthermore, users of the electricity transfer system network can establish user profiles corresponding to their user accounts that permit such users to manage their user accounts (e.g., provide user data, make payments for using electricity transfer network system, etc.), to review electric vehicle data and/or electric vehicle rechargeable energy storage system (EVRESS) data for their electric vehicles (as described below), to reserve any of the various electricity transfer systems of the electricity transfer system network, etc. Similarly, the operating entity can maintain manager profiles (e.g., via one or more computer databases of ETSN computer system 109) corresponding to the user accounts that aggregate user data (e.g., personal information, financial and/or accounting information, etc.), electric vehicle data, and/or EVRESS data relating to the users (the relevance of which is discussed in further detail below) and that make available the user data, the electric vehicle data, and/or the EVRESS data to the users (e.g., via the user profiles) and the operating entity. Users can access and/or manage their user profiles via a user interface of ETS 100, as described below, and/or remotely via their personal computing device (e.g., a desktop computer system, a laptop computer system, and/or any suitable mobile electronic computer system, such as, for example, a tablet computer system, and/or a smart phone, etc.).

Implementing ETS 100 as part of the electricity transfer system network can enhance at least some of the functionality of ETS 100 (e.g., reducing demand on electric grid 107, provide ancillary services to electric grid 107, and shift times of electric loads on electric grid 107, etc.) by aggregating that functionality of ETS 100 across the electricity transfer system network (i.e., multiple electricity transfer systems). In other words, the effects of ETS 100 with respect to electric grid 107 can be multiplied by the total number of electricity transfer systems of which the electricity transfer system network is comprised and that are currently operating.

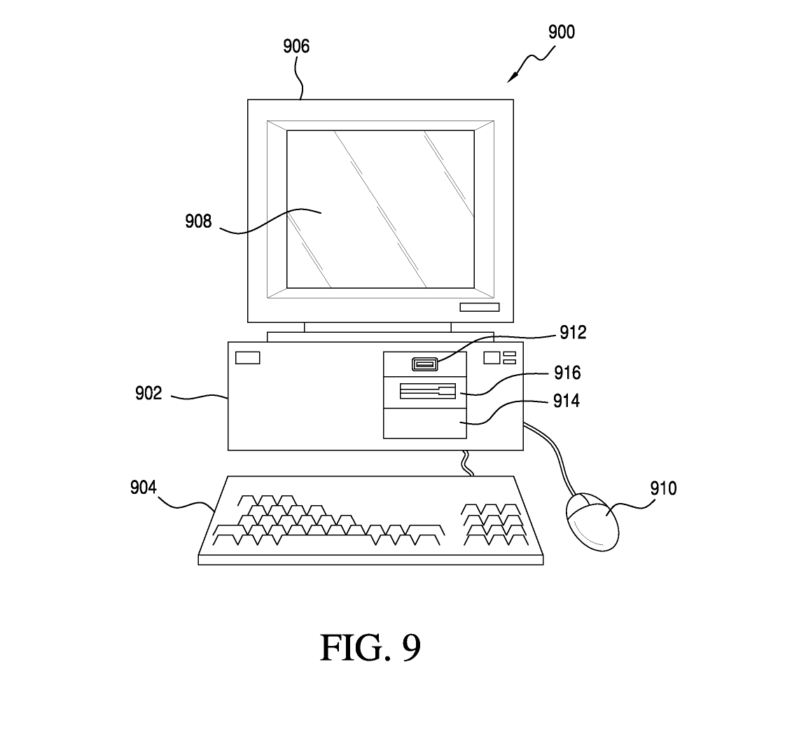

Each ETS 100, whether or not being part of the electricity transfer system network, can comprise electric vehicle charging station (EVCS) 103, electricity transfer system rechargeable energy storage system (ETSRESS) 104, and control module 105. Meanwhile, ETS 100, EVCS 103, and/or control module 105 can comprise communication module 106. In some embodiments, ETS 100 can comprise ETSN computer system 109 and/or electric vehicle charging station (EVCS) computer system 110. In other embodiments, one of ETSN computer system 109 and/or EVCS computer system 110 can be omitted. ETSN computer system 109 and/or EVCS computer system 110 can be similar or identical to computer system 900 (FIG. 9) as described below. In various embodiments, ETSN computer system 109 and/or EVCS computer system 110 can also comprise communication module 106.

In many embodiments, EVCS 103 can comprise ETSRESS 104 and control module 105. However, in other embodiments, ETSRESS 104 can be separate from (e.g., external to) EVCS 103, and/or control module 105 can be separate from (e.g., external) or even located remotely from EVCS 103. Control module 105 can be implemented as software and/or as hardware.

As illustrated in FIG. 1, for example, ETSRESS 104 and/or control module 105 can be integrated components of EVCS 103. In these examples, control module 105 can comprise and can be implemented as EVCS computer system 110. Accordingly, EVCS computer system 110 can operate to perform some or all of the functions of control module 105, as described below. Meanwhile, in other examples, control module 105 can comprise and be implemented as ETSN computer system 109, which can operate to perform some or all of the functions of control module 105, as applicable. As indicated, in some embodiments, control module 105 can comprise and can be implemented as both EVCS computer system 110 and ETSN computer system 109. In these embodiments, EVCS computer system 110 operates to perform some of the functions of control module 105 while ETSN computer system 109 operates to (a) perform other functions of control module 105 and/or (b) support EVCS computer system 110 in performing the functions of control module 105. Even where performing some or all of the functions of control module 105 is not implemented by ETSN computer system 109, control module 105 can still be in communication with ETSN computer system 109 (e.g., via communication module 106) as will be better understood in context with the description of ETSN computer system 109 provided below.

EVCS 103 is configured to be coupled to (e.g., between) electric grid 107 and EVRESS 101 in order to be able to receive electricity from electric grid 107 and to be able to make available the electricity provided from electric grid 107 to EVRESS 101. Meanwhile, ETSRESS 104 is also configured to be coupled to (e.g., between) electric grid 107 and EVRESS 101 in order to be able to receive and store electricity from electric grid 107 and to be able to make available the electricity provided from electric grid 107 and stored at ETSRESS 104 to EVRESS 101. In many embodiments, ETSRESS 104 also makes the electricity stored in ETSRESS 104 available to be used by electric grid 107, as described in further detail below.

EVCS 103 and ETSRESS 104 can be coupled to electric grid 107 and EVRESS 101 in any of various arrangements. For example, EVCS 103 and ETSRESS 104 can be coupled to electric grid 107 through an individual input coupling (or separate input couplings) and through an individual output coupling (or separate output couplings). Arranging EVCS 103 and ETSRESS 104 with an individual input coupling and an individual output coupling can be more convenient, practical, and/or efficient than using separate input and output couplings, particularly, where ETSRESS 104 is integral with EVCS 103, but doing so may not be practical or even feasible where ETSRESS 104 is separate from EVCS 103. Regardless of the arrangement implemented, EVCS 103 and ETSRESS 104 can be configured such that EVCS 103 can provide electricity to EVRESS 101 when ETSRESS 104 is not providing electricity to EVRESS 101 and vice versa, and such that EVCS 103 and ETSRESS 104 can also both provide electricity to EVRESS 101 simultaneously. EVCS 103 and ETSRESS 104 can also be configured such that EVCS 103 can receive electricity from electric grid 107 when ETSRESS 104 is not receiving electricity from electric grid 107 and vice versa, and such that EVCS 103 and ETSRESS 104 can also both receive electricity from electric grid 107 simultaneously. EVCS 103 and ETSRESS 104 can be coupled to electric grid 107 in parallel or in series (e.g., such that ETSRESS 104 is coupled to electric grid 107 through EVCS 103, or such that EVCS 103 is coupled to electric grid 107 through ETSRESS 104).

Control module 105 is configured to control (e.g., in real time) when EVCS 103 and ETSRESS 104 receive electricity from electric grid 107 and when EVCS 103 and ETSRESS 104 make electricity available to EVRESS 101. Control module 105 can also be configured to condition (e.g., in real time) the electricity received by EVCS 103 and/or ETSRESS 104 and made available to EVRESS 101. In applicable embodiments, control module 105 can also control (e.g., in real time) when ETSRESS 104 makes electricity available to electric grid 107 and/or condition (e.g., in real time) the electricity made available to electric grid 107. Accordingly, EVCS 103 and ETSRESS 104 can be coupled to electric grid 107 and EVRESS 101 by any suitable circuitry permitting control module 105 to control the passage of electricity (e.g., via one or more contactors) and/or condition electricity (e.g., via one or more devices configured to establish, maintain, and/or change electric voltage(s)/electric current(s) of the electricity) passing from (a) electric grid 107 to EVCS 103 and/or ETSRESS 104 and (b) EVCS 103 and/or ETSRESS 104 to EVRESS 101. Control module 105 can be configured to condition the electricity that EVCS 103 and/or ETSRESS 104 makes available to EVRESS 101 based on one or more static charging condition(s) and/or one or more dynamic charging condition(s), both of which are discussed further below. Furthermore, control module 105 can be configured to (a) convert the electricity that EVCS 103 makes available to EVRESS 101 and/or provides to ETSRESS 104 (e.g., from alternating current to direct current) and/or (b) convert the electricity that EVCS 103 makes available to electric grid 107 from EVRESS 101 and/or ETSRESS 104 (e.g., from direct current to alternating current).

Meanwhile, communication module 106 is configured to provide communication (e.g., in real time) between EVCS 103, control module 105, EVCS computer system 110, and/or ETSN computer system 109. Communication module 106 can also be configured to communicate (e.g., in real time) with electric grid computer system 108 of electric grid 107 and/or electric vehicle 102 (i.e., the EMS of EVRESS 101 of electric vehicle 102). Accordingly, communication module 106 can comprise a communication network comprising (a) one or more components configured to provide wired communication (e.g., one or more data buses, such as, for example, universal serial bus(es); one or more networking cables, such as, for example, coaxial cable(s), optical fiber cable(s), twisted pair cable(s); any other suitable data cable, etc.) and/or (b) one or more components configured to provide wireless communication (e.g., one or more radio transceivers, one or more infrared transceivers, etc.) between EVCS 103, control module 105, EVCS computer system 110, ETSN computer system 109, electric grid computer system 108, and/or electric vehicle 102. Communication module 106 can be configured to operate using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The components forming the communication network of communication module 106 can be dependent on the network topologies and/or protocols in use, and vice versa.

ETSRESS 104 can be similar to EVRESS 101. For example, ETSRESS 104 can comprise (a) one or more batteries and/or one or more fuel cells, (b) one or more capacitive energy storage systems (e.g., super capacitors such as electric double-layer capacitors), and/or (c) one or more inertial energy storage systems (e.g., one or more flywheels). In many embodiments, the one or more batteries can comprise one or more rechargeable and/or non-rechargeable batteries. For example, the one or more batteries can comprise one or more lead-acid batteries, valve regulated lead acid (VRLA) batteries such as gel batteries and/or absorbed glass mat (AGM) batteries, nickel-cadmium (NiCd) batteries, nickel-zinc (NiZn) batteries, nickel metal hydride (NiMH) batteries, zebra (e.g., molten chloroaluminate (NaAlCl₄)) batteries, and/or lithium (e.g., lithium-ion (Li-ion)) batteries. However, in some embodiments, ETSRESS 104 can comprise a different electricity transfer rating and/or electric energy storage capacity than EVRESS 101.

Electric grid 107 can comprise one or more commercial electric grids and/or one or more personal electric grids. A commercial electric grid can refer to any conventional electric network operated by one or more utility companies, and a personal electric grid can refer to a personal electricity generation/distribution system owned and/or operated by one or more users of ETS 100 and/or one or more third parties other than utility companies. For example, a personal electric grid can comprise one or more photovoltaic panels, one or more wind turbines, one or more gas-powered generators, etc. and any electrical circuitry associated therewith. The commercial electric grid(s) and/or personal electric grid(s) can be administered via electric grid computer system 108. In many examples, a commercial electric grid can comprise one or more electrical networks of varying scale. Accordingly, a commercial electric grid can be defined by a geographical area (e.g., one or more continents, countries, states, municipalities, ZIP codes, regions, etc.) and/or defined by some other context, such as, for example, by which utility company or companies that operate the commercial electric grid. Meanwhile, the commercial electric grids can be administrated via electric grid computer system 108 by one or more utility companies managing and/or operating the commercial electric grids. Electric grid computer system 108 can be similar or identical to computer system 900 (FIG. 9) as described below.

EVCS 103 can comprise electric vehicle supply equipment configured to make electricity available to EVRESS 101 via direct current (DC) fast charging. Accordingly, EVCS 103 can be configured to make available the electricity such that the electricity comprises electric power, electric voltage, and electric current levels sufficient to fast charge EVRESS 101. For example, EVCS 103 can be configured to make electricity available comprising electric power greater than or equal to 100 kiloWatts (kW) and less than or equal to 300 kW.

ETS 100 can comprise a user interface. The user interface can permit users of ETS 100 to access their user profiles, manage their user accounts, and/or permit users to use ETS 100 to charge the EVRESS (e.g., EVRESS 101) of their electric vehicle (e.g., electric vehicle 102). Likewise, users of ETS 100 can provide payment (e.g., via charge card, credit card, debit card, cash, an e-commerce provider such as PayPal of San Jose, Calif., etc.) for using ETS 100 via the user interface. Users of ETS 100 can also manually enter static charging condition(s) of EVRESS 101, such as, for example, where EVRESS 101 does not comprise an EMS or where the EMS of EVRESS 101 is not configured to calculate and/or store static charging condition(s).

EVCS 103 can comprise the user interface of ETS 100. The user interface can comprise any suitable combination of interactive and/or passive input/output mechanisms (e.g., one or more electronic displays, such as, for example, touch screen electronic display(s), one or more keyboards, one or more keypads, one or more speakers, one or more magnetic stripe card readers, one or more radio frequency identification (RFID) transceivers, etc.) configured to permit users to access their user profiles, manage their user accounts, and/or permit users to use ETS 100 to charge the EVRESS (e.g., EVRESS 101) of their electric vehicle (e.g., electric vehicle 102). Accordingly, in applicable embodiments, users can manually enter static charging condition(s) passively, such as, for example, by interfacing a magnetic stripe card with the magnetic stripe reader or interfacing a RFID device (e.g., a fob) with the RFID transceiver where the magnetic stripe card and/or the RFID device are programmed with the static charging condition(s). In other embodiments, users can manually enter static charging condition(s) interactively, such as, for example, via touch screen electronic display(s), the keyboard(s), the keypad(s), etc.

ETS 100 (and EVCS 103) can comprise an electricity meter to meter electricity provided to EVRESS 101 by EVCS 103 and/or ETSRESS 104 as well as to electric grid 107 by ETSRESS 104. Meanwhile, ETS 100 (and EVCS 103) can comprise interlock provisions to prevent theft of electricity, etc.

EVCS 103 can comprise an electrical coupling mechanism configured to be coupled to EVRESS 101 in order to couple EVCS 103 and/or ETSRESS 104 thereto. Accordingly, EVCS 103 (and ETSRESS 104 when EVCS 103 comprises ETSRESS 104) can be configured to make the electricity available to EVRESS 101 via the electrical coupling mechanism. In some embodiments, ETSRESS 104 can comprise a separate electrical coupling mechanism similar to the electrical coupling mechanism of EVCS 103 rather than sharing the same electrical coupling mechanism, such as where EVCS 103 and ETSRESS 104 are configured to be separately coupled with EVRESS 101. Still, as mentioned above, this latter configuration may not be practical, generally, unless electric vehicle 102 is also configured with multiple connection ports by which to couple multiple electrical coupling mechanisms with EVRESS 101.

In some embodiments, the electrical coupling mechanism can comprise a conductive electrical coupling mechanism (e.g., a variant of the Society of Automotive Engineers (SAE) J1772 electrical connector configured for DC fast charging). Meanwhile, in other embodiments, the electrical coupling mechanism can comprise part or all of an inductive electrical coupling mechanism. Where the electrical coupling mechanism comprises only part of the inductive electrical coupling mechanism (e.g., a first part of the inductive electrical coupling mechanism, such as, for example, a probe or plug), electric vehicle 102 can comprise the other part of the inductive coupling mechanism (e.g., a second part of the inductive electrical coupling mechanism, such as, for example, a slot or receptacle). In these arrangements, electricity can be transmitted between the first and second parts of the inductive electrical coupling mechanism using high frequency (e.g., greater than or equal to approximately 10 kiloHertz (kHz) to less than or equal to approximately 200 kHz) alternating current (AC) and/or with high voltage and low current at the first part and low voltage and high current at the second part. Likewise, the second part of the inductive electrical coupling mechanism can be tailored to specifically accommodate the static charging conditions for any EVRESS 101 with which that second part is associated, and the electric voltage and frequency conditions of the first part can be held constant, regardless of the static charging conditions of the instant EVRESS 101, which makes the first part of the inductive coupling mechanism universal for use with any second part.

In many embodiments, the electrical coupling mechanism can also comprise at least part of communication module 106. That is to say, the electrical coupling mechanism can comprise wired components forming part of the communication network of communication module 106 that are configured to permit communication module 106 to communicate with electric vehicle 102 (i.e., the EMS of EVRESS 101 of electric vehicle 102). The wired components can be integrated with (e.g., via Powerline network protocol(s)), separate but bundled with, or separate and discrete from the electrical lines of the electrical coupling mechanism configured to pass electricity from EVCS 103 and/or ETRESS 104 to EVRESS 101. In other embodiments, communication module 106 can be configured to wirelessly communicate with electric vehicle 102 (i.e., the EMS of EVRESS 101 of electric vehicle 102), in which case, in still further embodiments, communication module 106 can be omitted from the electrical coupling mechanism.

Whether communicating with electric vehicle 102 wirelessly or through wired communication such as that described in the previous paragraph with respect to the electrical coupling mechanism, communication module 106 can be configured to interrogate electric vehicle 102 (i.e., the EMS of EVRESS 101 of electric vehicle 102) to identify static charging condition(s) of EVRESS 101. As part of interrogating electric vehicle 102 to identify static charging condition(s) of EVRESS 101, communication module 106 can be configured to determine whether EVRESS 101 comprises an EMS. Exemplary static charging condition(s) can comprise the nominal charging electric voltage of EVRESS 101, the maximum charging electric current of EVRESS 101, the optimal temperature range for charging EVRESS 101, etc. Meanwhile, communication module 106 can be configured to interrogate (e.g., periodically) electric vehicle 102 (i.e., the EMS of EVRESS 101 of electric vehicle 102) to identify one or more dynamic charging conditions of EVRESS 101 when communication module 106 communicates with electric vehicle 102 and/or when EVCS 103 and/or ETSRESS 104 are making electricity available to EVRESS 101. Exemplary dynamic charging conditions can comprise a measured and/or calculated internal temperature of EVRESS 101, a measured and/or calculated internal pressure of EVRESS 101, a measured and/or calculated internal resistance free electric voltage of EVRESS 101, a state of charge of EVRESS 101, a state of health of EVRESS 101, a measured and/or calculated electric current at EVRESS 101, a measured and/or calculated electric voltage at EVRESS 101, etc.

Internal resistance free electric voltage can refer to an electric voltage of EVRESS 101 when EVRESS 101 is neither receiving electricity from EVCS 103 and/or ETSRESS 104 nor providing electricity to electric vehicle 102. Accordingly, control module 105 can be configured to interrupt (e.g., periodically), as appropriate, when EVCS 103 and/or ETSRESS 104 make electricity available to EVRESS 101 so that EVRESS 101 is neither receiving electricity from EVCS 103 and/or ETSRESS 104 nor providing electricity to electric vehicle 102. This interrupt can be configured to approximately coincide in time with when communication module 106 interrogates electric vehicle 102 regarding the dynamic charging condition of the internal resistance free electric voltage of EVRESS 101.

The interval at which communication module 106 interrogates electric vehicle 102 and/or at which control module 105 interrupts when EVCS 103 and/or ETSRESS 104 make electricity available to EVRESS 101 can occur at one or more predetermined time intervals. Thus, the static charging condition(s) can also comprise the predetermined time interval(s), and/or the predetermined time interval(s) can be established by control module 105. Furthermore, in many embodiments, where one or more of the dynamic charging conditions require calculation, some or all of the dynamic charging conditions can be calculated by the EMS of EVRESS 101, and/or some or all of the dynamic charging conditions can be calculated by control module 105. In these embodiments, electric vehicle 102 (e.g., the EMS of EVRESS 101 of electric vehicle 102) can measure one or more variables (e.g., electric voltage at EVRESS 101, electric current at EVRESS 101, internal temperature of EVRESS 101, internal pressure of EVRESS 101, internal resistance of EVRESS 101, etc.) by which the EMS of EVRESS 101 and/or control module 105 can calculate the dynamic charging condition(s).

Meanwhile, communication module 106 can also be configured to gather electric vehicle data and/or electric vehicle rechargeable energy storage system (EVRESS) data when communication module 106 communicates with electric vehicle 102 (and the EMS of EVRESS 101 of electric vehicle 102). Communication module 106 can be configured to provide the electric vehicle data and/or the EVRESS data to ETSN computer system 109, such as, for example, for aggregation and storage in one or more computer databases (e.g., XML (Extensible Markup Language) database(s), MySQL database(s), and/or Oracle® database(s)) of ETSN computer system 109, as mentioned previously with respect to the description of the electricity transfer system network. The electric vehicle data and/or the EVRESS data can further be indexed as a searchable group of individual data files stored in one or more memory storage modules of ETSN computer system 109 such that the electric vehicle data and/or the EVRESS data can be called by users via their user profiles and/or by control module 105. Exemplary electric vehicle data can comprise maintenance requirements for electric vehicle 102, locations of electric vehicle 102 (e.g., provided by a global positioning system of electric vehicle 102), etc. Meanwhile, exemplary EVRESS data can comprise any of the dynamic charging condition(s).

Using the above-described architecture, ETS 100 can be implemented to reduce consumer demand on electric grid 107, to provide ancillary services to electric grid 107, and/or to shift when ETS 100 draws electricity from electric grid 107 (which can be referred to collectively as “ETSRESS-related functions” and for which further details are provided below) while also being able to make electricity available to EVRESS 101 via EVCS 103 and/or ETSRESS 104. Specifically, through communication module 106, control module 105 can determine when EVCS 103 receives electricity from electric grid 107, when EVCS 103 makes electricity available to electric grid 107, when EVCS 103 makes electricity available to EVRESS 101, when ETSRESS 104 receives electricity from electric grid 107, when ETSRESS 104 makes electricity available to electric grid 107, and/or when ETSRESS 104 makes electricity available to EVRESS 101. Regarding when EVCS 103 makes electricity available to electric grid 107, EVCS 103 can make electricity available to electric grid 107 from EVRESS 101 and/or ETSRESS 104. Whether some or all of the functionality of ETS 100 can be implemented can depend on whether electric grid 107 comprises only one or both of commercial electric grid(s) and personal electric grid(s), as described above. For example, where electric grid 107 does not include commercial electric grid(s), reducing consumer demand on electric grid 107 and/or providing ancillary services to electric grid 107 may be inapplicable. The following describes the manner in which control module 105 controls and/or determines when EVCS 103 receives electricity from electric grid 107, when EVCS 103 makes electricity available to electric grid 107, when EVCS 103 makes electricity available to EVRESS 101, when ETSRESS 104 receives electricity from electric grid 107, when ETSRESS 104 makes electricity available to electric grid 107, and/or when ETSRESS 104 makes electricity available to EVRESS 101.

As an introductory matter, ETS 100 need not be presently making electricity available (e.g., via EVCS 103 and/or ETSRESS 104) to EVRESS 101 in order for ETS 100 to provide the above referenced ETSRESS-related functions. Likewise, when ETS 100 is both charging EVRESS 101 and providing the ETSRESS-related functions, ETS 100 can be configured such that charging EVRESS 101 takes priority or such that the ETSRESS-related functions take priority, either as selected by the users of ETS 100 or on a predetermined/pre-programmed basis. The manner in which control module 105 controls and/or determines when EVCS 103 receives electricity from electric grid 107, when EVCS 103 makes electricity available to electric grid 107, when EVCS 103 makes electricity available to EVRESS 101, when ETSRESS 104 receives electricity from electric grid 107, when ETSRESS 104 makes electricity available to electric grid 107, and/or when ETSRESS 104 makes electricity available to EVRESS 101 can be structured in various layers.

On a first layer, control module 105 can determine whether ETS 100 is currently being requested by a user of ETS 100 (e.g., via the user interface of ETS 100 or the user's personal computing device) to charge EVRESS 101. If not, control module 105 can be concerned only with providing ETSRESS-related functions until at some time where ETS 100 does receive a request by a user of ETS 100 to charge EVRESS 101. However, if ETS 100 is currently being requested to charge EVRESS 101, control module 105 prompts communication module 106 to interrogate electric vehicle 102 for the static charging conditions and/or the initial dynamic charging conditions of EVRESS 101. If communication module 106 determines that EVRESS 101 does not comprise an EMS, communication module 106 can interrogate the user interface for manually entered static charging conditions. Approximately simultaneously with communication module 106 obtaining the static charging conditions and/or initial dynamic charging conditions of EVRESS 101, communication module 106 can also provide any relevant user data regarding the charge (e.g., a desired charge level, a desired charge time, a price ceiling on the cost of electricity, a desired distance to drive electric vehicle 102, a selection to charge as cheaply as possible, a selection to charge in a manner to maximize the health and/or lifetime of EVRESS 101, a selection to charge as cleanly environmentally speaking as possible, etc.) received from the user's user account/profile or manually via the user interface. Control module 105 can then begin making electricity available to EVRESS 101 via EVCS 103 and/or ETSRESS 104 at the maximum electric current and nominal electric voltage provided by the static charging conditions. At this first layer, control module 105 can also utilize communication module 106 to obtain electric vehicle data and/or EVRESS data from ETSN computer system 109 in order to establish a history of use of electric vehicle 102. Furthermore, control module 105 can also utilize communication module 106 to obtain the user's utility electricity rate schedule from the user interface, ETSN computer system 109, or electric grid computer system 108 in order to determine the user's electricity cost at various times and on various dates.

On a second layer, control module 105 can periodically receive new dynamic charging conditions from communication module 106 (e.g., based on the predetermined time interval). Using the dynamic charging conditions, control module 105 can define parameters by which to make available and/or condition the electricity being made available to EVRESS 101 to satisfy the selected manner of charging EVRESS 101 established at the first layer (though subject to change by the user). In many embodiments, at this second layer, control module 105 can make available and/or condition the electricity by comparing the internal resistance free electric voltage of EVRESS 101 against a reference voltage. The reference voltage can be predetermined, selected by the user, and/or dynamically updated by control module 105 according to a measured ambient temperature, any of the various dynamic charging conditions, a particular degree of change in the electric current of EVRESS 101, etc. At this second layer, control module 105 can also utilize communication module 106 to maintain communication with electric grid 108 to determine any changes in the cost of electricity.

Finally, on a third layer, control module 105 can control and/or determine when EVCS 103 receives electricity from electric grid 107, when EVCS 103 makes electricity available to EVRESS 101, when ETSRESS 104 receives electricity from electric grid 107, when ETSRESS 104 makes electricity available to electric grid 107, and/or when ETSRESS 104 makes electricity available to EVRESS 101 in order to provide the ETSRESS-related functions of ETS 100.

In order to permit ETS 100 to reduce consumer demand on electric grid 107, control module 105 can be configured to control when ETSRESS 104 makes electricity available to EVRESS 101 based on consumer demand on electric grid 107. Consumer demand can refer to actual and/or projected total demand for electricity by customers of electric grid 107. Accordingly, when ETS 100 is making electricity available to EVRESS 101, control module 105 can be configured to scale back making electricity available to EVRESS 101 via EVCS 103 and ramp up making electricity available to EVRESS 101 via ETSRESS 104 during a period of heavy consumer demand on electric grid 107 to offset consumer demand on electric grid 107 by decreasing the electricity that EVCS 103 needs to draw from electric grid 107 in order to help maintain a steady-state demand on electric grid 107. Meanwhile, when consumer demand is lighter, control module 105 can scale back making electricity available to EVRESS 101 via ETSRESS 104 and ramp up making electricity available to EVRESS 101 via EVCS 103 to preserve the electricity stored at ETSRESS 104 for periods of heavier consumer demand on electric grid 107 and to help maintain a steady-state demand on electric grid 107. During periods of less consumer demand, control module 105 can also have ETSRESS 105 receive electricity from electric grid 107 to charge ETSRESS 104 in order to help maintain a steady-state demand on electric grid 107. As mentioned above, with respect to the description of the first layer of control of control module 105, ETS 100 need not be making electricity available to EVRESS 101 in order for control module 105 to implement ETSRESS 104 to reduce consumer demand on electric grid 107. Meanwhile, control module 105 can determine when to provide reduction of consumer demand on electric grid (by consuming less electricity at EVCS 103), based on request by the one or more utility companies (e.g., via communication via communication module 106 with electric grid computer system 108), based on referencing the customer rate schedule as provided in one of the manners described above with respect to the description of the first layer of control by control module 105, and/or based on referencing pre-programmed values stored at EVCS computer system 110. Consumer demand reduction can be advantageous both for supporting electric grid 107 and for reducing electricity costs for users of ETS 100 where those users pay for electricity on the basis of demand and/or on the basis of varying electricity rates.

In order to permit ETS 100 to provide ancillary service(s) to electric grid 107, ETSRESS 104 can be configured to receive electricity from electric grid 107 and/or make electricity available to electric grid 107, as determined by control module 105. Exemplary ancillary services can comprise (1) reactive electric power/electric voltage control, (2) electric loss compensation, (3) electric load following, (4) electric grid protection, and/or (5) electric energy balancing, etc. Reactive electric power/electric voltage control can refer to providing electricity to and/or drawing electricity from electric grid 107 to maintain a balanced electric power, electric voltage, and/or frequency of the electricity in electric grid 107. Meanwhile, electric loss compensation can refer to compensating for electric power losses in electricity as the electricity passes from electricity generation devices to electric loads. Electric load following can refer to quickly providing electricity to and/or drawing electricity from electric grid 107 (e.g., for approximately minute intervals) in response to approximately real time and/or near real time fluctuations (e.g., minute to minute) of electric load versus generated electricity. Electric energy balancing can be similar to electric load following, but can occur for longer intervals (e.g., multiple minutes to hours) and can be in response to fluctuations detected over longer time intervals (e.g., multiple minutes to hours). Finally, electric grid protection can refer to compensating for large spikes in electricity in electric grid 107 to prevent those spikes from damaging electric grid 107. Control module 105 can determine when to provide ancillary service(s) and/or which ancillary service(s) to provide based on request by the one or more utility companies (e.g., via communication (e.g., in real time) via communication module 106 with electric grid computer system 108).

In order to permit ETS 100 to shift when ETS 100 draws electricity from electric grid 107, control module 105 can be configured to control when ETSRESS 104 receives electricity from electric grid 107 based on the time of day and/or the date. For example, ETSRESS 104 advantageously permits ETS 100 to draw some or all of the electricity stored in ETSRESS 104 from electric grid 107 during times and/or on days having the least cost or at least a lesser cost of electricity (e.g., early morning and/or late in the evening). As a result, ETS 100 can make available some or all of the electricity that ETS 100 makes available (i.e., via ETSRESS 104) to EVRESS 101 at a lower electricity cost than might be available at the time of day and/or on the date when a user actually requests to charge EVRESS 101 with ETS 100. Of course, control module 105 may still need to use EVCS 103 to make available some of the electricity necessary to complete the desired charge of EVRESS 101 (e.g., where ETSRESS 104 has insufficient energy storage capacity to provide the requested charge alone), but even in these scenarios, ETSRESS 104 can make available some of the electricity to reduce the final cost of electricity for charging EVRESS 101. Control module 105 can utilize communication (e.g., in real time) via communication module 106 with electric grid computer system 108 to determine the relevant electricity costs and/or can determine the relevant electricity costs by referencing the customer rate schedule as provided in one of the manners described above with respect to the description of the first layer of control by control module 105 and/or by referencing pre-programmed values stored at EVCS computer system 110.

In many embodiments, control module 105 can be configured to determine when ETSRESS 104 receives electricity from electric grid 107, when ETSRESS 104 makes electricity available to electric grid 107, and/or when ETSRESS 104 makes electricity available to EVRESS 101, all such that ETSRESS 104 maintains sufficient stored electricity to perform the ETSRESS-related functions or at least to maximize any opportunities for ETSRESS 104 to perform the ETSRESS-related functions. Still, in some scenarios, control module 105 could determine that neither EVCS 103 nor ETSRESS 104 make electricity available to electric grid 107.

Although the operational characteristics of control module 105 are described as comprising layers, this description is for convenience of description and should not be construed as indicating that these operational characteristics necessarily occur sequentially. Rather, one or more of the various layers can occur approximately simultaneously with each other. Indeed, in many scenarios, control module 105 provides the functionality described with respect to layer two and layer three approximately simultaneously with each other. Meanwhile, parts of layer two can be omitted where ETS 100 is not making electricity available to EVRESS 101. Likewise, parts of layer three can be omitted where ETS 100 is not making electricity available to EVRESS 101.

As a general matter, when control module 105 uses communication module 106 to communicate with electric grid computer system 108, control module 105 can do so directly or indirectly through ETSN computer system 109. That is to say, in some embodiments, ETSN computer system 109 can obtain data from electric grid computer system 108 and make it available to control module 105.

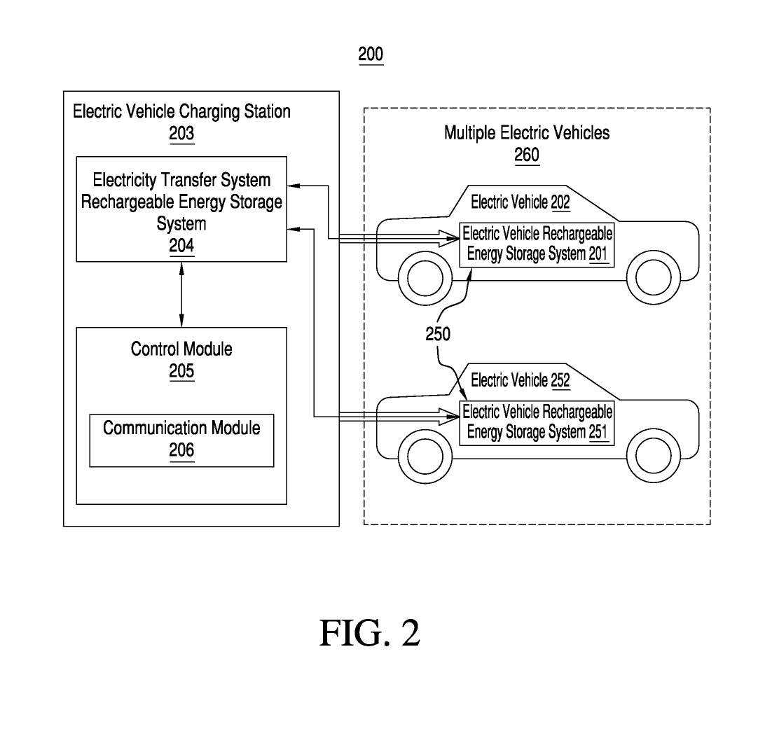

Turning to the next drawings, FIG. 2 illustrates a representative block diagram of electricity transfer system (ETS) 200 for making electricity available (e.g., via fast charging) to multiple electric vehicle rechargeable energy storage systems (MEVRESS) 250, according to an embodiment, where each electric vehicle rechargeable energy storage system (EVRESS) of MEVRESS 250 corresponds and/or is configured to be integrated with one electric vehicle of multiple electric vehicles 260. For example, MEVRESS 250 can comprise EVRESS 201 of electric vehicle 202 and can comprise EVRESS 251 of electric vehicle 252. Meanwhile, multiple electric vehicles 260 can comprise electric vehicle 202 and electric vehicle 252. Each EVRESS of MEVRESS 250 (e.g., EVRESS 201, EVRESS 251, etc.) can be similar or identical to EVRESS 101 (FIG. 1), and each electric vehicle of multiple electric vehicles 260 (e.g., electric vehicle 202, electric vehicle 252, etc.) can be similar or identical to electric vehicle 102 (FIG. 1). ETS 200 is merely exemplary and is not limited to the embodiments presented herein. ETS 200 can be employed in many different embodiments or examples not specifically depicted or described herein.

ETS 200 can be similar to ETS 100 (FIG. 1). For example, ETS 200 can comprise electric vehicle charging station (EVCS) 203, electricity transfer system rechargeable energy storage system (ETSRESS) 204, and control module 205. Meanwhile, ETS 200, EVCS 203, and/or control module 205 can comprise communication module 206. EVCS 203 can be similar to EVCS 103 (FIG. 1); ETSRESS 204 can be similar to ETSRESS 104 (FIG. 1); control module 205 can be similar to control module 105 (FIG. 1); and communication module 206 can be similar to communication module 106 (FIG. 1).

Building on the functionality of control module 105 (FIG. 1), control module 205 can be configured to control when EVCS 203 and/or ETSRESS 204 make electricity available to MEVRESS 250 and/or to condition the electricity made available to MEVRESS 250 in a manner similar to that described above with respect to control module 105 (FIG. 1), EVCS 103 (FIG. 1), ETSRESS 104 (FIG. 1), and EVRESS 101 (FIG. 1) while also adding a layer of operation by which control module 205 also determines which EVRESS(s) of MEVRESS 250 receives electricity and/or under what conditions to make that electricity available. Control module 205 can be configured to make electricity available to each EVRESS of MEVRESS 250 sequentially, in parallel, and/or according to some other charging scheme. For example, control module 205 can cycle between making electricity available from EVCS 203 and/or ETSRESS 204 to any EVRESS(s) of MEVRESS 250 based on the respective state of charge for each EVRESS of MEVRESS 250, based on the respective ability of each EVRESS of MEVRESS 250 to receive electric current from EVCS 203 and/or ETSRESS 204, etc.

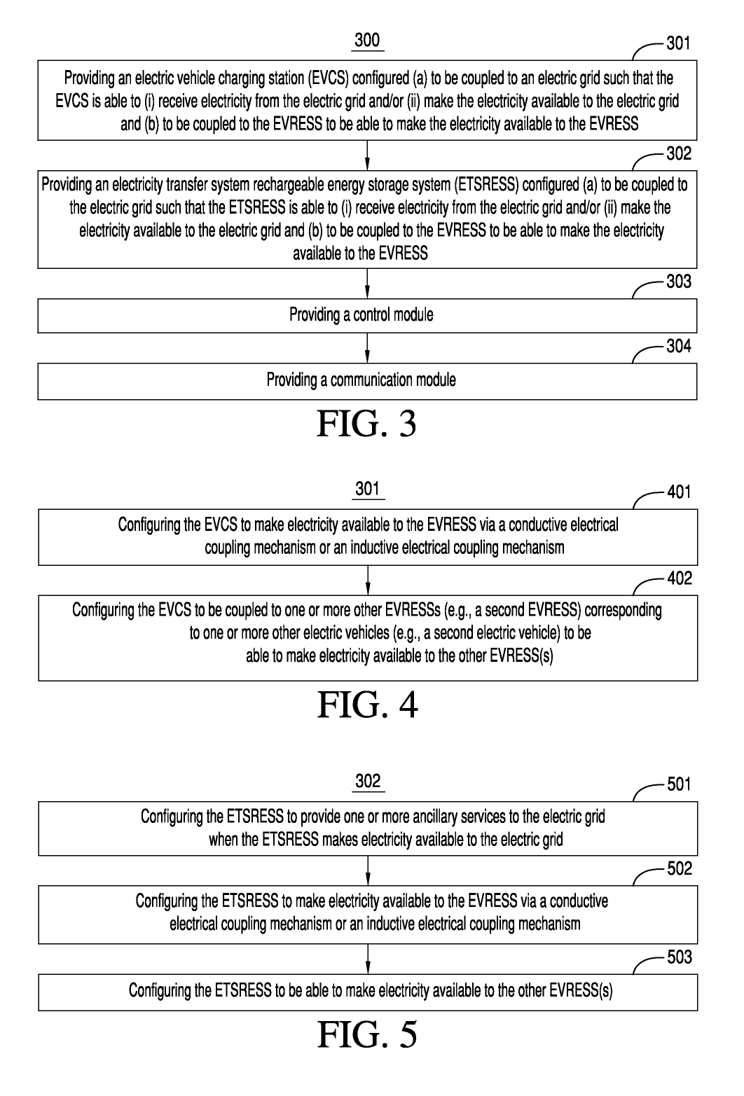

Turning to the next drawing, FIG. 3 illustrates a flow chart for an embodiment of method 300 for providing an electricity transfer system (ETS) for making electricity available to an electric vehicle rechargeable energy storage system (EVRESS) of an electric vehicle. Method 300 is merely exemplary and is not limited to the embodiments presented herein. Method 300 can be employed in many different embodiments or examples not specifically depicted or described herein. In some embodiments, the procedures, the processes, and/or the activities of method 300 can be performed in the order presented. In other embodiments, the procedures, the processes, and/or the activities of method 300 can be performed in any other suitable order. In still other embodiments, one or more of the procedures, the processes, and/or the activities in method 300 can be combined or skipped. The ETS can be similar or identical to ETS 100 (FIG. 1) and/or ETS 200 (FIG. 2). The EVRESS can be similar or identical to EVRESS 101 (FIG. 1), EVRESS 201 (FIG. 2), EVRESS 251 (FIG. 2), and/or any other EVRESS of MEVRESS 250 (FIG. 2). Likewise, the electric vehicle can be similar or identical to electric vehicle 102 (FIG. 1), electric vehicle 202 (FIG. 2), electric vehicle 252 (FIG. 2), and/or any other electric vehicles of multiple electric vehicles 260 (FIG. 2).

Method 300 comprises procedure 301 of providing an electric vehicle charging station (EVCS) configured (a) to be coupled to an electric grid such that the EVCS is able to receive electricity from the electric grid and (b) to be coupled to the EVRESS to be able to make the electricity available to the EVRESS. The EVCS can be similar or identical to EVCS 103 (FIG. 1) and/or EVCS 203 (FIG. 2). The electric grid can be similar or identical to electric grid 107 (FIG. 1). FIG. 4 illustrates an exemplary procedure 301.

Referring to FIG. 4, procedure 301 (and/or method 300) can comprise process 401 of configuring the EVCS to make electricity available to the EVRESS via a conductive electrical coupling mechanism or an inductive electrical coupling mechanism. The conductive electrical coupling mechanism can be similar or identical to the conductive electrical coupling mechanism described above with respect to ETS 100 (FIG. 1). The inductive electrical coupling mechanism can be similar or identical to the inductive electrical coupling mechanism described above with respect to ETS 100 (FIG. 1).

Procedure 301 (and/or method 300) can also comprise process 402 of configuring the EVCS to be coupled to one or more other EVRESSs (e.g., a second EVRESS) corresponding to one or more other electric vehicles (e.g., a second electric vehicle) to be able to make electricity available to the other EVRESS(s). Any of the other EVRESSs can be similar or identical to EVRESS 101 (FIG. 1), EVRESS 201 (FIG. 2), EVRESS 251 (FIG. 2), and/or any other EVRESS of MEVRESS 250 (FIG. 2). Meanwhile, any of the other electric vehicles can be similar or identical to electric vehicle 102 (FIG. 1), electric vehicle 202 (FIG. 2), electric vehicle 252 (FIG. 2), and/or any other electric vehicles of multiple electric vehicles 260 (FIG. 2). The sequence of processes 401 and 402 can be reversed or can occur simultaneously, with each other.

Returning now to FIG. 3, method 300 also comprises procedure 302 of providing an electricity transfer system rechargeable energy storage system (ETSRESS) configured (a) to be coupled to the electric grid such that the ETSRESS is able to receive electricity from the electric grid and to be able to make available the electricity to the electric grid and (b) to be coupled to the EVRESS to be able to make available the electricity to the EVRESS and to receive the electricity from the EVRESS. The ETSRESS can be similar or identical to ETSRESS 104 (FIG. 1) and/or ETSRESS 204 (FIG. 2). FIG. 5 illustrates an exemplary procedure 302.

Referring to FIG. 5, procedure 302 (and/or method 300) can comprise process 501 of configuring the ETSRESS to provide one or more ancillary services to the electric grid when the ETSRESS makes electricity available to the electric grid. The ancillary service(s) can be similar or identical to the ancillary service(s) described above with respect to ETS 100 (FIG. 1).

Procedure 302 (and/or method 300) can also comprise process 502 of configuring the ETSRESS to make electricity available to the EVRESS via a conductive electrical coupling mechanism or an inductive electrical coupling mechanism. The conductive electrical coupling mechanism can be similar or identical to the conductive electrical coupling mechanism described above with respect to ETS 100 (FIG. 1), and the inductive electrical coupling mechanism can be similar or identical to the inductive electrical coupling mechanism described above with respect to ETS 100 (FIG. 1). The conductive electrical coupling mechanism can be the same conductive electrical coupling mechanism as described above with respect to process 401. Likewise, the inductive electrical coupling mechanism can be the same inductive electrical coupling mechanism as described above with respect to process 401.

Procedure 302 (and/or method 300) can further comprise process 503 of configuring the ETSRESS to be able to make electricity available to the other EVRESS(s). The sequence of processes 501-503 can also be reversed or otherwise changed.

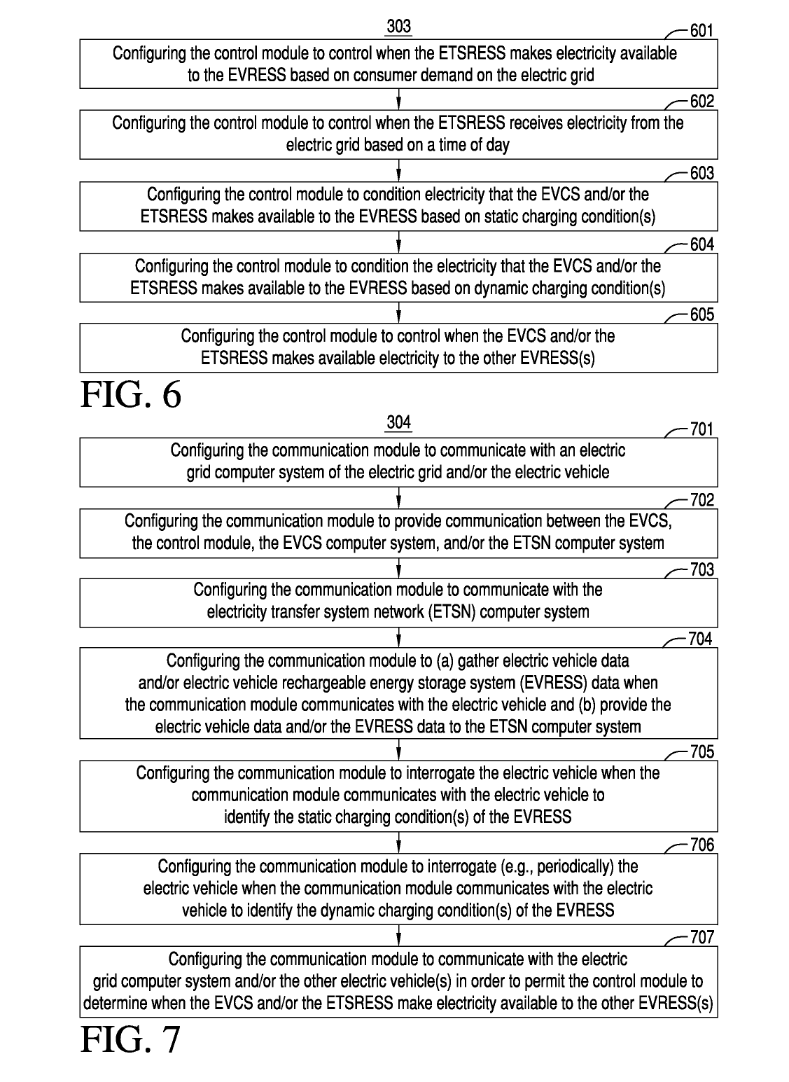

Returning again to FIG. 3, method 300 comprises procedure 303 of providing a control module. In many embodiments, performing procedure 303 can comprise configuring the control module to control when the EVCS receives electricity from the electric grid, when the EVCS makes electricity available to the electric grid, when the EVCS makes electricity available to the EVRESS, when the ETSRESS receives electricity from the electric grid, when the ETSRESS makes electricity available to the electric grid, and/or when the ETSRESS makes electricity available to the EVRESS. The control module can be similar or identical to control module 105 (FIG. 1) and/or control module 205 (FIG. 2). FIG. 6 illustrates an exemplary procedure 303.

Referring to FIG. 6, procedure 303 (and/or method 300) can comprise process 601 of configuring the control module to control when the ETSRESS makes electricity available to the EVRESS based on consumer demand on the electric grid.

Procedure 303 (and/or method 300) can also comprise process 602 of configuring the control module to control when the ETSRESS receives electricity from the electric grid based on a time of day.

Procedure 303 (and/or method 300) can further comprise process 603 of configuring the control module to condition electricity that the EVCS and/or the ETSRESS makes available to the EVRESS based on static charging condition(s). The static charging condition(s) can be similar or identical to the static charging condition(s) described above with respect to ETS 100 (FIG. 1).

Procedure 303 (and/or method 300) can additionally comprise process 604 of configuring the control module to condition the electricity that the EVCS and/or the ETSRESS makes available to the EVRESS based on dynamic charging condition(s). The dynamic charging condition(s) can be similar or identical to the dynamic charging condition(s) described above with respect to ETS 100 (FIG. 1).

Procedure 304 (and/or method 300) can also comprise process 605 of configuring the control module to control when the EVCS and/or the ETSRESS makes electricity available to the other EVRESS(s). The sequence of processes 601-605 can be reversed or otherwise changed.

Returning once again to FIG. 3, method 300 further comprises procedure 304 of providing a communication module. The communication module can be similar or identical to communication module 106 (FIG. 1) and/or communication module 206 (FIG. 2). The sequence of procedures 301-304 can be reversed or otherwise changed. In many embodiments of method 300 in FIG. 3, performing procedure 301 can comprise performing one or more of procedure 302, procedure 303, and/or procedure 304. FIG. 7 illustrates an exemplary procedure 304.

Referring to FIG. 7, procedure 304 (and/or method 300) can comprise process 701 of configuring the communication module to communicate with an electric grid computer system of the electric grid and/or the electric vehicle. The electric grid computer system can be similar or identical to electric grid computer system 107 (FIG. 1).

Procedure 304 (and/or method 300) can also comprise process 702 of configuring the communication module to provide communication between the EVCS, the control module, the EVCS computer system, and/or the ETSN computer system. The EVCS computer system can be similar or identical to EVCS computer system 110 (FIG. 1), and the ETSN computer system can be similar or identical to ETSN computer system 109 (FIG. 1).

Performing process 701 and/or process 702 can permit the control module to determine when the EVCS receives electricity from the electric grid, when the EVCS makes electricity available to the EVRESS, when the EVCS makes electricity available to the electric grid, when the ETSRESS receives electricity from the electric grid, when the ETSRESS makes electricity available to the electric grid, and/or when the ETSRESS makes electricity available to the EVRESS.

Procedure 304 (and/or method 300) can additionally comprise process 703 of configuring the communication module to communicate with the electricity transfer system network (ETSN) computer system.

Procedure 304 (and/or method 300) can also comprise process 704 of configuring the communication module to (a) gather electric vehicle data and/or electric vehicle rechargeable energy storage system (EVRESS) data when the communication module communicates with the electric vehicle and (b) provide the electric vehicle data and/or the EVRESS data to the ETSN computer system. The electric vehicle data can be similar or identical to the electric vehicle data described above with respect to ETS 100 (FIG. 1), and the EVRESS data can be similar or identical to the EVRESS data described above with respect to ETS 100 (FIG. 1).

Procedure 304 (and/or method 300) can further comprise process 705 of configuring the communication module to interrogate the electric vehicle when the communication module communicates with the electric vehicle to identify the static charging condition(s) of the EVRESS.

Procedure 304 (and/or method 300) can still further comprise process 706 of configuring the communication module to interrogate (e.g., periodically) the electric vehicle when the communication module communicates with the electric vehicle to identify the dynamic charging condition(s) of the EVRESS.

Procedure 304 (and/or method 300) can additionally comprise process 707 of configuring the communication module to communicate with the electric grid computer system and/or the other electric vehicle(s) in order to permit the control module to determine when the EVCS and/or the ETSRESS make electricity available to the other EVRESS(s). The sequence of processes 701-707 can be reversed or otherwise changed.

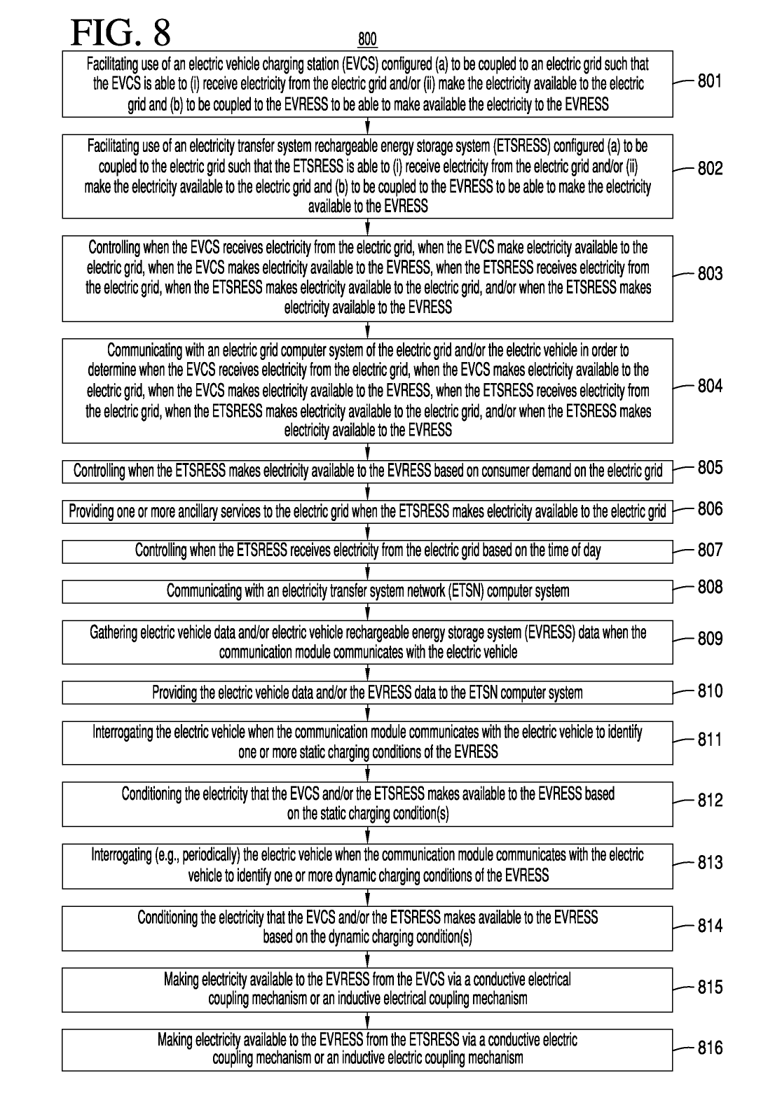

Turning to the next drawing, FIG. 8 illustrates a flow chart for an embodiment of method 800 of making electricity available to an electric vehicle rechargeable energy storage system (EVRESS) of an electric vehicle. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any other suitable order. In still other embodiments, one or more of the procedures, the processes, and/or the activities in method 800 can be combined or skipped. The EVRESS can be similar or identical to EVRESS 101 (FIG. 1), EVRESS 201 (FIG. 2), EVRESS 251 (FIG. 2), and/or any other EVRESS of MEVRESS 250 (FIG. 2). Likewise, the electric vehicle can be similar or identical to electric vehicle 102 (FIG. 1), electric vehicle 202 (FIG. 2), electric vehicle 252 (FIG. 2), and/or any other electric vehicles of multiple electric vehicles 260 (FIG. 2).

Method 800 can comprise procedure 801 of facilitating use of an electric vehicle charging station (EVCS) configured (a) to be coupled to an electric grid such that the EVCS is able to (i) receive electricity from the electric grid and/or (ii) make the electricity available to the electric grid and (b) to be coupled to the EVRESS to be able to make the electricity available to the EVRESS. The EVCS can be similar or identical to EVCS 103 (FIG. 1) and/or EVCS 203 (FIG. 2). The electric grid can be similar or identical to electric grid 107 (FIG. 1).

Method 800 can also comprise procedure 802 of facilitating use of an electricity transfer system rechargeable energy storage system (ETSRESS) configured (a) to be coupled to the electric grid such that the ETSRESS is able to (i) receive electricity from the electric grid and/or (ii) make the electricity available to the electric grid and (b) to be coupled to the EVRESS to be able to (i) receive electricity from the EVRESS and/or (ii) make the electricity available to the EVRESS. The ETSRESS can be similar or identical to ETSRESS 104 (FIG. 1) and/or ETSRESS 204 (FIG. 2). In many embodiments, performing process 801 can comprise performing process 802, or vice versa.

In some embodiments, performing procedure 801 and/or procedure 802 can comprise facilitating use of the EVCS and/or the ETSRESS as part of an electricity transfer system network.

Method 800 can further comprise procedure 803 of controlling when the EVCS receives electricity from the electric grid, when the EVCS makes electricity available to the electric grid, when the EVCS makes electricity available to the EVRESS, when the ETSRESS receives electricity from the electric grid, when the ETSRESS makes electricity available to the electric grid, and/or when the ETSRESS makes electricity available to the EVRESS. In many embodiments, procedure 803 can comprise controlling when the EVCS or ETSRESS receives electricity from or makes electricity available to the electric grid and/or the EVRESS in a manner similar or identical to that described above with respect to ETS 100 (FIG. 1).

Method 800 can additionally comprise procedure 804 of communicating with an electric grid computer system of the electric grid and/or the electric vehicle in order to determine when the EVCS receives electricity from the electric grid, when the EVCS makes electricity available to the electric grid, when the EVCS makes electricity available to the EVRESS, when the ETSRESS receives electricity from the electric grid, when the ETSRESS makes electricity available to the electric grid, and/or when the ETSRESS makes electricity available to the EVRESS. In many embodiments, procedure 804 can comprise communicating with an electric grid computer system of the electric grid and/or the electric vehicle in order to determine when the EVCS or the ETSRESS receives electricity from or makes electricity available to the electric grid and/or the EVRESS in a manner similar or identical to that described above with respect to ETS 100 (FIG. 1).

Method 800 can still further comprise procedure 805 of controlling when the ETSRESS makes electricity available to the EVRESS based on consumer demand on the electric grid. In many embodiments, procedure 805 can comprise controlling when the ETSRESS makes electricity available to the EVRESS based on consumer demand on the electric grid in a manner similar or identical to that described with respect to ETS 100 (FIG. 1).

Method 800 can also comprise procedure 806 of providing one or more ancillary services to the electric grid when the ETSRESS makes electricity available to the electric grid. In many embodiments, procedure 806 can comprise controlling when the ETSRESS provides the ancillary service(s) to the electric grid with the control module in a manner similar or identical to that described above with respect to ETS 100 (FIG. 1).

Method 800 can additionally comprise procedure 807 of controlling when the ETSRESS receives electricity from the electric grid based on the time of day. In many embodiments, procedure 807 can comprise controlling when the ETSRESS receives electricity from the electric grid based on the time of day in a manner similar or identical to that described above with respect to ETS 100 (FIG. 1). In many embodiments, one or more of procedure 805, procedure 806, and/or procedure 807 can be omitted.

Method 800 can further comprise procedure 808 of communicating with an electricity transfer system network (ETSN) computer system, such as, for example, with the communication module. The ETSN computer system can be similar or identical to ETSN computer system 109 (FIG. 1).

Method 800 can still further comprise procedure 809 of gathering electric vehicle data and/or electric vehicle rechargeable energy storage system (EVRESS) data when the communication module communicates with the electric vehicle. The electric vehicle data can be similar or identical to the electric vehicle data described above with respect to ETS 100 (FIG. 1), and the EVRESS data can be similar or identical to the EVRESS data described above with respect to ETS 100 (FIG. 1).

Method 800 can also comprise procedure 810 of providing the electric vehicle data and/or the EVRESS data to the ETSN computer system, such as, for example, with the communication module.

Method 800 can additionally comprise procedure 811 of interrogating the electric vehicle when the communication module communicates with the electric vehicle to identify one or more static charging conditions of the EVRESS. The static charging condition(s) can be similar or identical to the static charging condition(s) described above with respect to ETS 100 (FIG. 1). Procedure 811 can comprise interrogating the electric vehicle when the communication module communicates with the electric vehicle to identify the static charging condition(s) of the EVRESS in a manner similar or identical to that described above with respect to ETS 100 (FIG. 1).

Method 800 can further comprise procedure 812 of conditioning the electricity that the EVCS and/or the ETSRESS makes available to the EVRESS based on the static charging condition(s). Procedure 812 can comprise conditioning the electricity that the EVCS and/or the ETSRESS makes available to the EVRESS based on the static charging condition(s) in a manner similar or identical to that described above with respect to ETS 100 (FIG. 1).

Method 800 can still further comprise procedure 813 of interrogating (e.g., periodically) the electric vehicle when the communication module communicates with the electric vehicle to identify one or more dynamic charging conditions of the EVRESS. The dynamic charging condition(s) can be similar or identical to the dynamic charging conditions described above with respect to ETS 100 (FIG. 1). Procedure 813 can comprise interrogating (e.g., periodically) the electric vehicle when the communication module communicates with the electric vehicle to identify the dynamic charging condition(s) of the EVRESS in a manner similar or identical to that described above with respect to ETS 100 (FIG. 1).

Method 800 can also comprise procedure 814 of conditioning the electricity that the EVCS and/or the ETSRESS makes available to the EVRESS based on the dynamic charging condition(s). In many embodiments, procedure 814 can comprise conditioning the electricity that the EVCS and/or the ETSRESS makes available to the EVRESS based on the dynamic charging condition(s) in a manner similar or identical to that described above with respect to ETS 100 (FIG. 1).

Method 800 can additionally comprise procedure 815 of making electricity available to the EVRESS from the EVCS via a conductive electrical coupling mechanism or an inductive electrical coupling mechanism. The conductive electrical coupling mechanism and the inductive electrical coupling mechanism can be similar or identical to the conductive electrical coupling mechanism and the inductive electrical coupling mechanism, respectively, as described above with respect to ETS 100 (FIG. 1).

Method 800 can further comprise procedure 816 of making electricity available to the EVRESS from the ETSRESS via a conductive electric coupling mechanism or an inductive electric coupling mechanism. The conductive electrical coupling mechanism and the inductive electrical coupling mechanism can be similar or identical to the conductive electrical coupling mechanism and the inductive electrical coupling mechanism, respectively, as described above with respect to ETS 100 (FIG. 1). In many embodiments and/or examples, procedure 815 and procedure 816 can be performed approximately simultaneously with each other.

In many embodiments, one or more of procedures 801 through 816 can be performed for one or more other EVRESSs corresponding to one or more other electric vehicles. Any of the other EVRESSs can be similar or identical to EVRESS 101 (FIG. 1), EVRESS 201 (FIG. 2), EVRESS 251 (FIG. 2), and/or any other EVRESS of MEVRESS 250 (FIG. 2). Meanwhile, any of the other electric vehicles can be similar or identical to electric vehicle 102 (FIG. 1), electric vehicle 202 (FIG. 2), electric vehicle 252 (FIG. 2), and/or any other electric vehicles of multiple electric vehicles 260 (FIG. 2).

In some embodiments, some of method 800 can be implemented as computer instructions configured to be run on one or more processors of one or more computer systems and storable at one or more memory storage units of the one or more computer systems. The computer system(s) suitable for implementing some of method 800 can be similar or identical to ETSN computer system 110 (FIG. 1) and/or EVCS 109 (FIG. 1). In general, the computer system(s) suitable for implementing some of method 800 can be similar or identical to computer system 900 (FIG. 9) as described hereafter.

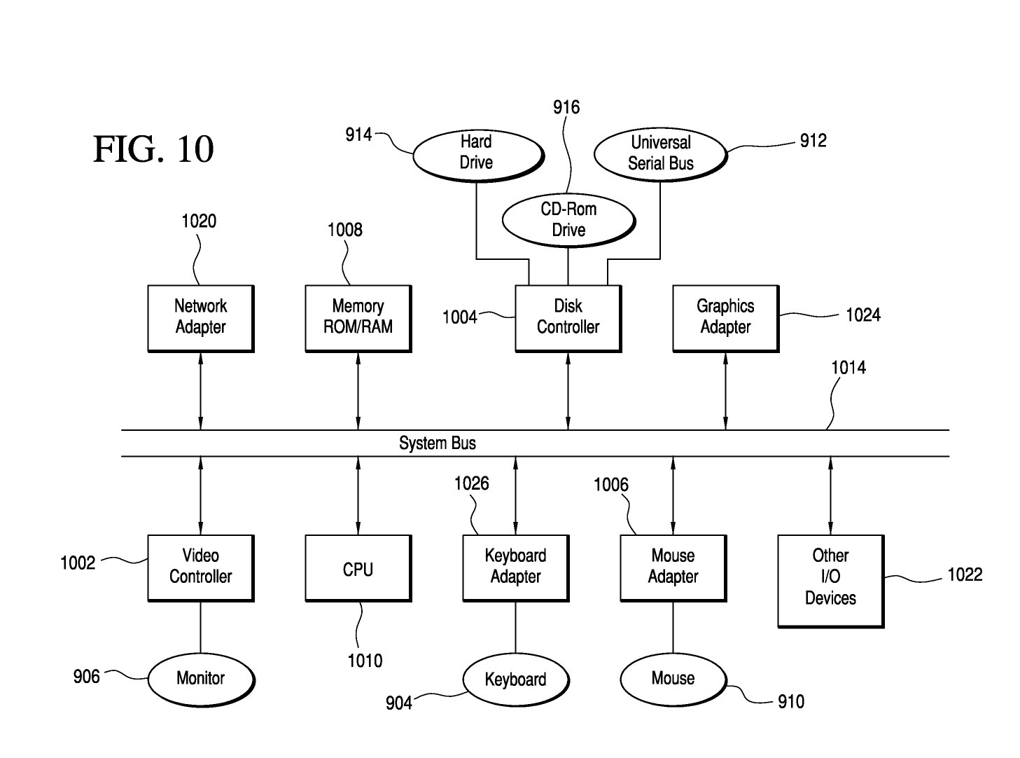

Turning again to the next drawing, FIG. 9 illustrates an exemplary embodiment of computer system 900, all of which or a portion of which can be suitable for implementing an embodiment of electric grid computer system 108 (FIG. 1), ETSN computer system 109 (FIG. 1), EVCS computer system 110 (FIG. 1), control module 105 (FIG. 1), communication module 106 (FIG. 1), control module 205 (FIG. 2), and/or any of various other elements of ETS 100 (FIG. 1) and/or ETS 200 (FIG. 2) as well as any of the various procedures, processes, and/or activities of method 300 (FIG. 3) and/or method 800 (FIG. 8). As an example, a different or separate one of chassis 902 (and its internal components) can be suitable for implementing electric grid computer system 108 (FIG. 1), ETSN computer system 109 (FIG. 1), EVCS computer system 110 (FIG. 1), control module 105 (FIG. 1), communication module 106 (FIG. 1), control module 205 (FIG. 2), etc. Furthermore, one or more elements of computer system 900 (e.g., refreshing monitor 906, keyboard 904, and/or mouse 910, etc.) can also be appropriate for implementing electric grid computer system 108 (FIG. 1) and/or ETSN computer system 109 (FIG. 1). Computer system 900 comprises chassis 902 containing one or more circuit boards (not shown), Universal Serial Bus (USB) 912, Compact Disc Read-Only Memory (CD-ROM) and/or Digital Video Disc (DVD) drive 916, and hard drive 914. A representative block diagram of the elements included on the circuit boards inside chassis 902 is shown in FIG. 10. Central processing unit (CPU) 1010 in FIG. 10 is coupled to system bus 1014 in FIG. 10. In various embodiments, the architecture of CPU 1010 can be compliant with any of a variety of commercially distributed architecture families.

Turning to FIG. 10, system bus 1014 also is coupled to memory storage unit 1008, where memory storage unit 1008 comprises both read only memory (ROM) and random access memory (RAM). Non-volatile portions of memory storage unit 1008 or the ROM can be encoded with a boot code sequence suitable for restoring computer system 900 (FIG. 9) to a functional state after a system reset. In addition, memory storage unit 1008 can comprise microcode such as a Basic Input-Output System (BIOS). In some examples, the one or more memory storage units of the various embodiments disclosed herein can comprise memory storage unit 1008, a USB-equipped electronic device, such as, an external memory storage unit (not shown) coupled to universal serial bus (USB) 912 (FIGS. 9-10), hard drive 914 (FIGS. 9-10), and/or CD-ROM or DVD drive 916 (FIGS. 9-10). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 1010.

In the depicted embodiment of FIG. 10, various I/O devices such as disk controller 1004, graphics adapter 1024, video controller 1002, keyboard adapter 1026, mouse adapter 1006, network adapter 1020, and other I/O devices 1022 can be coupled to system bus 1014. Keyboard adapter 1026 and mouse adapter 1006 are coupled to keyboard 904 (FIGS. 9-10) and mouse 910 (FIGS. 9-10), respectively, of computer system 900 (FIG. 9). While graphics adapter 1024 and video controller 1002 are indicated as distinct units in FIG. 10, video controller 1002 can be integrated into graphics adapter 1024, or vice versa in other embodiments. Video controller 1002 is suitable for refreshing monitor 906 (FIGS. 9-10) to display images on a screen 908 (FIG. 9) of computer system 900 (FIG. 9). Disk controller 1004 can control hard drive 914 (FIGS. 9-10), USB 912 (FIGS. 9-10), and CD-ROM drive 916 (FIGS. 9-10). In other embodiments, distinct units can be used to control each of these devices separately.

In some embodiments, network adapter 1020 can comprise and/or be implemented as a WNIC (wireless network interface controller) card (not shown) plugged or coupled to an expansion port (not shown) in computer system 900 (FIG. 9). In other embodiments, the WNIC card can be a wireless network card built into computer system 900 (FIG. 9). A wireless network adapter can be built into computer system 900 by having wireless communication capabilities integrated into the motherboard chipset (not shown), or implemented via one or more dedicated wireless communication chips (not shown), connected through a PCI (peripheral component interconnector) or a PCI express bus of computer system 900 (FIG. 9) or USB 912 (FIG. 9). In other embodiments, network adapter 1020 can comprise and/or be implemented as a wired network interface controller card (not shown). Accordingly, communications module 106 (FIG. 1) and/or communications module 206 (FIG. 2) can comprise a network adapter similar or identical to network adapter 1020.

Although many other components of computer system 900 (FIG. 9) are not shown, such components and their interconnection are well known to those of ordinary skill in the art. Accordingly, further details concerning the construction and composition of computer system 900 and the circuit boards inside chassis 902 (FIG. 9) are not discussed herein.

When computer system 900 in FIG. 9 is running, program instructions stored on a USB-equipped electronic device connected to USB 912, on a CD-ROM or DVD in CD-ROM and/or DVD drive 916, on hard drive 914, or in memory storage unit 1008 (FIG. 10) are executed by CPU 1010 (FIG. 10). A portion of the program instructions, stored on these devices, can be suitable for carrying out at least part of ETS 100 (FIG. 1) and/or ETS 200 (FIG. 2) as well as any of the various procedures, processes, and/or activities of method 300 (FIG. 3) and/or method 800 (FIG. 8).

Although computer system 900 is illustrated as a desktop computer in FIG. 9, there can be examples where computer system 900 may take a different form factor while still having functional elements similar to those described for computer system 900. In some embodiments, computer system 900 may comprise a single computer, a single server, or a cluster or collection of computers or servers, or a cloud of computers or servers. Typically, a cluster or collection of servers can be used when the demand on computer system 900 exceeds the reasonable capability of a single server or computer.

Meanwhile, in some embodiments, EVCS computer system 110 (FIG. 1) may not have the level of sophistication and/or complexity of ETSN computer system 109 (FIG. 1) and/or electric grid computer system 108 (FIG. 1). For example, electric grid computer system 108 (FIG. 1), ETSN computer system 109 (FIG. 1), and/or EVCS computer system 110 (FIG. 1) can have only those processing capabilities and/or memory storage capabilities as are reasonably necessary to perform the functionality, described above with respect to control module 105 (FIG. 1), communication module 106 (FIG. 1), and/or ETS 100 (FIG. 1), as applicable. In a more detailed example, EVCS 110 (FIG. 1) could be implemented as a microcontroller comprising flash memory, or the like. Reducing the sophistication and/or complexity of any of electric grid computer system 108 (FIG. 1), ETSN computer system 109 (FIG. 1), and/or EVCS computer system 110 (FIG. 1) can reduce the size and/or cost of implementing ETS 100 (FIG. 1), as applicable. Nonetheless, in other embodiments, any of electric grid computer system 108 (FIG. 1), ETSN computer system 109 (FIG. 1), and/or EVCS computer system 110 (FIG. 1) may need additional sophistication and/or complexity to operate as desired.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 301 through 304 of FIG. 3, processes 401 and 402 of FIG. 4, processes 501 through 503 of FIG. 5, processes 601 through 605 of FIG. 6, processes 701 through 707 of FIG. 7, and/or procedures 801 through 816 of FIG. 8 may be comprised of many different procedures, processes, and activities and be performed by many different modules, in many different orders, that any element of FIGS. 1-10 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) An electricity transfer system for making electricity available to an electric vehicle rechargeable energy storage system of an electric vehicle, the electric vehicle rechargeable energy storage system being configured with an electricity transfer rating of greater than or equal to approximately (¼)C and with an electric energy storage capacity of greater than or equal to approximately 1 kiloWatt-hour, the electricity transfer system comprising:
an electric vehicle charging station configured (a) to be coupled to an electric grid such that the electric vehicle charging station is able to (i) receive the electricity from the electric grid and (ii) make available the electricity to the electric grid and (b) to be coupled to the electric vehicle rechargeable energy storage system to be able to make the electricity available to the electric vehicle rechargeable energy storage system;
an electricity transfer system rechargeable energy storage system configured (a) to be coupled to the electric grid such that the electricity transfer system rechargeable energy storage system is able to (i) receive the electricity from the electric grid and (ii) make available the electricity to the electric grid and (b) to be coupled to the electric vehicle rechargeable energy storage system to be able to make the electricity available to the electric vehicle rechargeable energy storage system;
a control module; and
a communication module configured to communicate with the control module;
wherein:
the control module is configured to control when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system; and
the communication module is configured to communicate with an electric grid computer system of the electric grid and the electric vehicle in order to permit the control module to determine when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system.

2) The electricity transfer system of claim 1 wherein:
the electric vehicle charging station comprises the electricity transfer system rechargeable energy storage system, the control module, and the communication module.

3) The electricity transfer system of claim 1 wherein at least one of:
the control module is configured to control when the electricity transfer system rechargeable energy storage system makes the electricity available to the electric vehicle rechargeable energy storage system based on at least existing consumer demand on the electric grid;
the electricity transfer system rechargeable energy storage system is configured to provide at least one ancillary service to the electric grid when the electricity transfer system rechargeable energy storage system makes the electricity available to the electric grid; or
the control module is configured to control when the electricity transfer system rechargeable energy storage system receives the electricity from the electric grid based on at least a time of day.

4) The electricity transfer system of claim 1 wherein:
the communication module is further configured to communicate with an electricity transfer system network computer system.

5) The electricity transfer system of claim 4 further comprising:
the electricity transfer system network computer system.

6) The electricity transfer system of claim 4 wherein:
the communication module is configured to (a) gather at least one of electric vehicle data or electric vehicle rechargeable energy storage system data when the communication module communicates with the electric vehicle and (b) provide the at least one of the electric vehicle data or the electric vehicle rechargeable energy storage system data to the electricity transfer system network computer system.

7) The electricity transfer system of claim 1 wherein:
when the communication module communicates with the electric vehicle, the communication module is configured to interrogate the electric vehicle to identify one or more static charging conditions of the electric vehicle rechargeable energy storage system; and
based on the one or more static charging conditions, the control module is configured to condition the electricity that one or both of the electric vehicle charging station and the electricity transfer system rechargeable energy storage system makes available to the electric vehicle rechargeable energy storage system.

8) The electricity transfer system of claim 1 wherein:
when the communication module communicates with the electric vehicle, the communication module is configured to periodically interrogate the electric vehicle to identify one or more dynamic charging conditions of the electric vehicle rechargeable energy storage system; and
based on the one or more dynamic charging conditions, the control module is configured to condition the electricity that one or both of the electric vehicle charging station and the electricity transfer system rechargeable energy storage system makes available to the electric vehicle rechargeable energy storage system.

9) The electricity transfer system of claim 1 wherein:
the electric vehicle charging station is configured to make the electricity available to the electric vehicle rechargeable energy storage system via an inductive coupling mechanism; and
the electricity transfer system rechargeable energy storage system is configured to make the electricity available to the electric vehicle rechargeable energy storage system via the inductive coupling mechanism.

10) The electricity transfer system of claim 1 wherein:
the electric vehicle charging station is further configured to be coupled to a second electric vehicle rechargeable energy storage system of a second electric vehicle to be able to make the electricity available to the second electric vehicle rechargeable energy storage system;
the electricity transfer system rechargeable energy storage system is further configured to be able to make the electricity available to the second electric vehicle rechargeable energy storage system;
the control module is further configured to control when the electric vehicle charging station makes the electricity available to the second electric vehicle rechargeable energy storage system and when the electricity transfer system rechargeable energy storage system makes the electricity available to the second electric vehicle rechargeable energy storage system; and
the communication module is further configured to communicate with the electric grid computer system and the second electric vehicle in order to permit the control module to determine when the electric vehicle charging station makes the electricity available to the second electric vehicle rechargeable energy storage system and when the electricity transfer system rechargeable energy storage system makes the electricity available to the second electric vehicle rechargeable energy storage system.

11) A method for providing an electricity transfer system for making electricity available to an electric vehicle rechargeable energy storage system of an electric vehicle, the electric vehicle rechargeable energy storage system being configured with an electricity transfer rating of greater than or equal to approximately (¼)C and with an electric energy storage capacity of greater than or equal to approximately 1 kiloWatt-hour, the method comprising:
providing an electric vehicle charging station configured (a) to be coupled to an electric grid such that the electric vehicle charging station is able to (i) receive the electricity from the electric grid and (ii) make the electricity available to the electric grid and (b) to be coupled to the electric vehicle rechargeable energy storage system to be able to make the electricity available to the electric vehicle rechargeable energy storage system;
providing an electricity transfer system rechargeable energy storage system configured (a) to be coupled to the electric grid such that the electricity transfer system rechargeable energy storage system is able to (i) receive the electricity from the electric grid and (ii) make the electricity available to the electric grid and (b) to be coupled to the electric vehicle rechargeable energy storage system to be able to make the electricity available to the electric vehicle rechargeable energy storage system;
providing a control module, wherein providing the control module comprises configuring the control module to control when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system; and
providing a communication module, wherein providing the communication module comprises configuring the communication module to communicate with an electric grid computer system of the electric grid and the electric vehicle in order to permit the control module to determine when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system.

12) The method of claim 11 wherein:
providing the electric vehicle charging station comprises the providing the electricity transfer system rechargeable energy storage system and the providing the control module.

13) The method of claim 11 further comprising at least one of:
configuring the control module to control when the electricity transfer system rechargeable energy storage system makes the electricity available to the electric vehicle rechargeable energy storage system based on at least existing consumer demand on the electric grid;
configuring the electricity transfer system rechargeable energy storage system to provide at least one ancillary service to the electric grid when the electricity transfer system rechargeable energy storage system makes the electricity available to the electric grid; or
configuring the control module to control when the electricity transfer system rechargeable energy storage system receives the electricity from the electric grid based on at least a time of day.

14) The method of claim 11 further comprising:
configuring the communication module to communicate with an electricity transfer system network computer system.

15) The method of claim 14 further comprising:
configuring the communication module to (a) gather at least one of electric vehicle data or electric vehicle rechargeable energy storage system data when the communication module communicates with the electric vehicle and (b) provide the at least one of the electric vehicle data or the electric vehicle rechargeable energy storage system data to the electricity transfer system network computer system.

16) The method of claim 11 further comprising:
configuring the communication module to interrogate the electric vehicle when the communication module communicates with the electric vehicle to identify one or more static charging conditions of the electric vehicle rechargeable energy storage system; and
configuring the control module, based on the one or more static charging conditions, to condition the electricity that one or both of the electric vehicle charging station and the electricity transfer system rechargeable energy storage system makes available to the electric vehicle rechargeable energy storage system.

17) The method of claim 11 further comprising:
configuring the communication module to periodically interrogate the electric vehicle when the communication module communicates with the electric vehicle to identify one or more dynamic charging conditions of the electric vehicle rechargeable energy storage system; and
configuring the control module, based on the one or more dynamic charging conditions, to condition the electricity that one or both of the electric vehicle charging station and the electricity transfer system rechargeable energy storage system makes available to the electric vehicle rechargeable energy storage system.

18) The method of claim 11 further comprising:
configuring the electric vehicle charging station to make the electricity available to the electric vehicle rechargeable energy storage system via an inductive coupling mechanism; and
configuring the electricity transfer system rechargeable energy storage system to make the electricity available to the electric vehicle rechargeable energy storage system via the inductive coupling mechanism.

19) The method of claim 11 further comprising:
configuring the electric vehicle charging station to be coupled to a second electric vehicle rechargeable energy storage system of a second electric vehicle to be able to make the electricity available to the second electric vehicle rechargeable energy storage system;
configuring the electricity transfer system rechargeable energy storage system to be able to make the electricity available to the second electric vehicle rechargeable energy storage system;
configuring the control module to control when the electric vehicle charging station makes the electricity available to the second electric vehicle rechargeable energy storage system and when the electricity transfer system rechargeable energy storage system makes the electricity available to the second electric vehicle rechargeable energy storage system; and
configuring the communication module to communicate with the electric grid computer system and the second electric vehicle in order to permit the control module to determine when the electric vehicle charging station makes the electricity available to the second electric vehicle rechargeable energy storage system and when the electricity transfer system rechargeable energy storage system makes the electricity available to the second electric vehicle rechargeable energy storage system.

20) A method of making electricity available to an electric vehicle rechargeable energy storage system of an electric vehicle, the electric vehicle rechargeable energy storage system being configured with an electricity transfer rating of greater than or equal to approximately (¼)C and with an electric energy storage capacity of greater than or equal to approximately 1 kiloWatt-hour, the method comprising:
facilitating use of an electric vehicle charging station configured (a) to be coupled to an electric grid such that the electric vehicle charging station is able to (i) receive the electricity from the electric grid and (ii) make the electricity available to the electric grid and (b) to be coupled to the electric vehicle rechargeable energy storage system to be able to make the electricity available to the electric vehicle rechargeable energy storage system;
facilitating use of an electricity transfer system rechargeable energy storage system configured (a) to be coupled to the electric grid such that the electricity transfer system rechargeable energy storage system is able to (i) receive the electricity from the electric grid and (ii) make the electricity available to the electric grid and (b) to be coupled to the electric vehicle rechargeable energy storage system to be able to make the electricity available to the electric vehicle rechargeable energy storage system;
controlling when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system; and
communicating with an electric grid computer system of the electric grid and the electric vehicle in order to determine when the electric vehicle charging station receives the electricity from the electric grid, when the electric vehicle charging station makes the electricity available to the electric grid, when the electric vehicle charging station makes the electricity available to the electric vehicle rechargeable energy storage system, when the electricity transfer system rechargeable energy storage system receives the electricity from the electric grid, when the electricity transfer system rechargeable energy storage system makes the electricity available to the electric grid, and when the electricity transfer system rechargeable energy storage system makes the electricity available to the electric vehicle rechargeable energy storage system.

21) The method of claim 20 wherein:
facilitating use of the electric vehicle charging station comprises facilitating use of the electricity transfer system rechargeable energy storage system.

22) The method of claim 20 further comprising at least one of:
controlling when the electricity transfer system rechargeable energy storage system makes the electricity available to the electric vehicle rechargeable energy storage system based on at least existing consumer demand on the electric grid;
providing at least one ancillary service to the electric grid when the electricity transfer system rechargeable energy storage system makes the electricity available to the electric grid; or
controlling when the electricity transfer system rechargeable energy storage system receives the electricity from the electric grid based on at least a time of day.

23) The method of claim 20 further comprising:
communicating with an electricity transfer system network computer system.

24) The method of claim 23 further comprising:
gathering at least one of electric vehicle data or electric vehicle rechargeable energy storage system data from the electric vehicle; and
providing the at least one of the electric vehicle data or the electric vehicle rechargeable energy storage system data to the electricity transfer system network computer system.

25) The method of claim 20 further comprising:
interrogating the electric vehicle to identify one or more static charging conditions of the electric vehicle rechargeable energy storage system; and
based on the one or more static charging conditions, conditioning the electricity that one or both of the electric vehicle charging station and the electricity transfer system rechargeable energy storage system makes available to the electric vehicle rechargeable energy storage system.

26) The method of claim 20 further comprising:
periodically interrogating the electric vehicle to identify one or more dynamic charging conditions of the electric vehicle rechargeable energy storage system; and
based on the one or more dynamic charging conditions, conditioning the electricity that one or both of the electric vehicle charging station and the electricity transfer system rechargeable energy storage system makes available to the electric vehicle rechargeable energy storage system.

27) The method of claim 20 further comprising:
making the electricity available to the electric vehicle rechargeable energy storage system from the electric vehicle charging station via an inductive coupling mechanism; and
making the electricity available to the electric vehicle rechargeable energy storage system from the electricity transfer system rechargeable energy storage system via the inductive coupling mechanism.

28) The method of claim 20 wherein:
the electric vehicle charging station is further configured to be coupled to a second electric vehicle rechargeable energy storage system of a second electric vehicle to be able to make the electricity available to the second electric vehicle rechargeable energy storage system;
the electricity transfer system rechargeable energy storage system is further configured to be able to make the electricity available to the second electric vehicle rechargeable energy storage system;
the method further comprises controlling when the electric vehicle charging station makes the electricity available to the second electric vehicle rechargeable energy storage system and when the electricity transfer system rechargeable energy storage system makes the electricity available to the second electric vehicle rechargeable energy storage system; and
the method further comprises determining when the electric vehicle charging station makes the electricity available to the second electric vehicle rechargeable energy storage system and when the electricity transfer system rechargeable energy storage system makes the electricity available to the second electric vehicle rechargeable energy storage system.
